(19) United States
(12) Patent Application Publication
(10) Pub. No.: US 2020/0370411 A1
(43) Pub. Date: Nov. 26, 2020

(54) METHOD FOR CALCULATING RECOVERY RATIO UNDER SECONDARY-TERTIARY COMBINATION DEVELOPMENT MODE

(71) Applicant: DAGANG OIL FIELD COMPANY OF CNPC, Tianjin (CN)

(72) Inventors: Pingqi Zhao, Tianjin (CN); Mingjun Cai, Tianjin (CN); Jialiang Zhang, Tianjin (CN); Ming Zhao, Tianjin (CN); Xi Wu, Tianjin (CN); Zhuxin Zhang, Tianjin (CN); Zhou Yu, Tianjin (CN)

(73) Assignee: DAGANG OIL FIELD COMPANY OF CNPC, Tianjin (CN)

(21) Appl. No.: 16/585,260

(22) Filed: Sep. 27, 2019

(30) Foreign Application Priority Data
May 23, 2019 (CN) 201910432917.1

(51) Int. Cl. E21B 47/00; E21B 43/20; G01V 99/00

(52) U.S. Cl. CPC E21B 47/00; G01V 99/005; E21B 43/20

(57) ABSTRACT

The present disclosure relates to the field of oil recovery technologies in an oilfield, and discloses a method for calculating recovery ratio under a secondary-tertiary combination development mode. The method includes: obtaining a sweep efficiency of water used in the process of a primary oil recovery E_{V1} and an oil displacement efficiency of the primary oil recovery E_{D1}; performing a secondary development of water flooding using injection-production conditions of the primary oil recovery, and obtaining an increment percentage of the E_{V1}, ω, caused by the secondary development of water flooding; directly performing a tertiary oil recovery using injection-production conditions of the primary oil recovery, and obtaining an increment percentage of the E_{V1}, ε, caused by the tertiary oil recovery and an oil displacement efficiency of the tertiary oil recovery E_{D2}; establishing a calculation model of a sweep efficiency of displacement media used in the process of the secondary-tertiary combination development E_{V2+3} according to E_{V1}, ω and ε; and calculating an increment in a recovery ratio under the secondary-tertiary combination development mode relative to a recovery ratio of the primary oil recovery ΔE_{R2+3}. The increment in the recovery ratio ΔE_{R2+3} as determined in the present disclosure takes the advantage of the secondary development of water flooding that has an integrated well network and the advantage of the tertiary oil recovery that can increase the oil displacement efficiency, and thereby can be used for theoretically understanding the increased value of the recovery ratio under the secondary-tertiary combination development mode.

### CROSS REFERENCE TO RELATED APPLICATIONS

This application claims the benefit of Chinese Patent Application No. 201910432917.1, filed May 23, 2019, entitled “METHOD FOR CALCULATING RECOVERY RATIO UNDER SECONDARY-TERTIARY COMBINATION DEVELOPMENT MODE” which is incorporated by reference as if fully set forth herein.

### FIELD OF THE INVENTION

The present disclosure relates to the field of oil recovery technologies in an oilfield, and discloses a method for calculating a recovery ratio under a secondary-tertiary combination development mode.

### BACKGROUND OF THE INVENTION

A primary oil recovery refers to an oil production manner where the crude oil is produced by means of the natural energy, and the energy at the bottom layer of the oil reservoir itself is used to achieve flow oil production and pumping oil production. When the oilfield for the flow oil production and pumping oil production reaches its economic efficiency limit, a secondary oil recovery is performed by injecting the oil layer with water or gas to supplement the elastic energy of the rock and fluid in the ground bed. A tertiary oil recovery refers to injecting fluid or heat into the oil layer and regulating the performance relationship between the oil, gas, water and rock to produce the remaining oil in the oil layer with physical and chemical actions.

Background of the “secondary-tertiary combination” development mode is as follows: according to the objective law in developing a high water-cut old oilfield, when the old oilfield is developed with the traditional primary development manner and reaches its limit state or meets a disposal condition, a new concept can be adopted to rebuild a development system for the old oilfield by recreating a well network structure and reorganizing a ground process, so as to greatly improve the ultimate recovery ratio of the oilfield.

Concept of the “secondary-tertiary combination” development mode is as follows: when the old oilfield comes into the high water-cut development stage, the arrangements of the hierarchical well network of the secondary development and tertiary oil recovery are optimized integrally by injecting fine water for development at the early stage, so as to improve the water-flooding recovery ratio. Then, in due course, the tertiary oil recovery is performed to obtain a cooperation effect achieved by integrating the advantage of the secondary development that has an integrated well network and the advantage of the tertiary oil recovery that can improve the oil-displacement efficiency. At the same time, the benefit evaluation and project management are implemented during the overall life cycle to optimize the oilfield development level and the total benefits.

In 2012, Dagang Oilfield made a deep analysis on the implementation effect of the secondary development and that of the tertiary oil recovery in the Gangxi Development Zone of Beidagang Oilfield, and evaluated the benefit of the program in combination with the low oil price in 2009. As shown from the evaluation results, under the condition of 60 USD/barrel, nearly 70% of the reserves in the old oilfield do not have any benefit potential in reorganizing the hierarchical well network for the secondary development of water flooding. In addition, for the tertiary oil recovery, although it can greatly improve the recovery ratio in the well control area of the tertiary oil recovery and has a certain economic benefit, the existing developed hierarchical well network cannot support the scale implementation of tertiary oil recovery, thereby still limiting the profit scale of the tertiary oil recovery. In general, for the old oilfield, with the increase in the production degree and the comprehensive water content, the number of areas that achieve the benefit development under a low-medium oil price merely by applying a single technique is decreasing, and the difficulty in stabilizing the benefit and production of the old oilfield is increasing. If only focusing on the oil production, stable production can be ensured by increasing the scale of investment and work. However, in the context of fluctuations in oil prices, the prospects for sustainable development are worrisome.

Dagang Oilfield has set up a scientific and technological innovation research project named “Establishment of Secondary-Tertiary Combination Development Mode for Complex Fault-Block Oilfield and its Practice in Stable Production and Benefit” since 2013. For the old oilfield with complex fault blocks in the high water-cut stage, the Dagang Oilfield puts its focus on the understanding of the secondary-tertiary combination theory and researches on the key technology. In addition, it also collaboratively and optimally arranges the secondary development of fine water-flooding oil recovery with the tertiary oil recovery having a hierarchical well network. The fine water flooding for potential seeking is firstly performed based on the water-flooding manner of the secondary development and then transferred to the tertiary oil recovery in due course, which peruses a timely connection between the fine water flooding and the tertiary oil recovery, optimizes the total recovery ratio and the economic benefits, ensures stable production and benefit of the oilfield, and improves the quality of oilfield development.

However, so far, there is no either a theoretical understanding that the secondary-tertiary combination development mode improves the recovery ratio and a method for calculating a recovery ratio.

### SUMMARY OF THE INVENTION

An object of the present disclosure is to theoretically understand that a secondary-tertiary combination development mode may improve the recovery ratio, and provide a method for calculating a recovery ratio under the secondary-tertiary combination development mode.

To achieve the object, the present disclosure provides a method for calculating a recovery ratio under a secondary-tertiary combination development mode that is a comprehensive development mode where secondary water flooding for potential seeking is performed firstly and then transferred to a tertiary oil recovery when oil production of a primary oil recovery reaches an economic efficiency limit, and the method for calculating a recovery ratio comprises:

obtaining a water-flooding sweep coefficient E_{V1} and an oil displacement efficiency E_{D1} of the primary oil recovery;

performing a secondary development of water flooding under injection-production conditions of the primary oil recovery, and obtaining a percentage ω of a water-flooding sweep coefficient increased by the secondary development of water flooding;

directly performing the tertiary oil recovery under injection-production conditions of the primary oil recovery, and obtaining a percentage ε of a sweep coefficient increased by the tertiary oil recovery and an oil displacement efficiency E_{D2} of the tertiary oil recovery;

calculating a sweep coefficient E_{V2+3} under the secondary-tertiary combination development mode in accordance with a formula (1) based on the water-flooding sweep coefficient E_{V1} of the primary oil recovery, the percentage ω of the water-flooding sweep coefficient increased by the secondary development of water flooding, and the percentage ε of a sweep coefficient increased by the tertiary oil recovery; and

E_{V2+3}=E_{V1}×(1+ω)×(1+ε) Formula (1)

predicting a recovery ratio under the secondary-tertiary combination development mode in accordance with the calculated sweep coefficient E_{V2+3} under the secondary-tertiary combination development mode and the oil displacement efficiency E_{D2} of the tertiary oil recovery, obtaining a recovery ratio of the primary oil recovery based on the water-flooding sweep coefficient E_{V1} and the oil displacement efficiency E_{D1} of the primary oil recovery, and calculating an increment ΔE_{R2+3} in the recovery ratio under the secondary-tertiary combination development mode relative to the recovery ratio of the primary oil recovery in accordance with a formula (2);

Δ_{R2+3}=E_{V2+3}×E_{D2}−E_{V1}×E_{D1} Formula (2).

Optionally, calculating the sweep coefficient E_{V2+3} under the secondary-tertiary combination development mode comprises:

performing the secondary development of water flooding under injection-production conditions of the primary oil recovery, and calculating a water-flooding sweep coefficient E_{V2} of the secondary development of water flooding in accordance with a formula (3);

E_{V2}=E_{V1}×(1+ω) Formula (3)

directly performing the tertiary oil recovery under injection-production conditions of the primary oil recovery, and calculating a sweep coefficient E_{V3} of the tertiary oil recovery in accordance with a formula (4); and

E_{V3}=E_{V1}×(1+ε) Formula (4)

calculating the sweep coefficient E_{V2+3} under the secondary-tertiary combination development mode in accordance with a formula (5) based on the water-flooding sweep coefficient E_{V2} of the secondary development of water flooding and the sweep coefficient E_{V3} of the tertiary oil recovery;

Optionally, the formula for calculating the recovery ratio is as follows: recovery ratio=sweep coefficient×oil displacement efficiency;

a recovery ratio E_{R1} of the primary oil recovery is calculated in accordance with a formula (6) based on the water-flooding sweep coefficient E_{V1} and the oil displacement efficiency E_{D1} of the primary oil recovery;

E_{R1}=E_{V1}×E_{D1} Formula (5)

an increment ΔE_{R2} in the recovery ratio of the secondary development of water flooding relative to the recovery ratio of the primary oil recovery is calculated in accordance with a formula (6) based on the water-flooding sweep coefficient E_{V2} and the oil displacement efficiency E_{D1} of the secondary development of water flooding; and

ΔE_{R2}=E_{V2}×E_{D1}−E_{R1} Formula (6)

an increment ΔE_{R3} in a recovery ratio of the tertiary oil recovery relative to the recovery ratio of the primary oil recovery is calculated in accordance with a formula (8) based on the sweep coefficient E_{V3} and the oil displacement efficiency E_{D2} of the tertiary oil recovery;

ΔE_{R3}=E_{V3}×E_{D2}−E_{R1} Formula (7).

Optionally, predicting the recovery ratio E_{R2+3} under the secondary-tertiary combination development mode in accordance with a formula (9) based on the sweep coefficient E_{V2+3} of the secondary-tertiary combination development mode and the oil displacement efficiency E_{D2} of the tertiary oil recovery; and

E_{R2+3}=E_{V2+3}×E_{D2} Formula (8)

calculating an increment ΔE_{R2+3} in the recovery ratio under the secondary-tertiary combination development mode relative to the recovery ratio of the primary oil recovery in accordance with a formula (9);

ΔE_{R2+3}=E_{V1}(1+ω)×(1+ε)×E_{D2}−E_{V1}×E_{D1} Formula(9)
wherein ΔE_{R2+3}ΔE_{R2}+ΔE_{R3}+ξ can be obtained from ΔE_{R2} and ΔE_{R3}; and ξ=E_{V1}×ω×[(1+ε)×E_{D2}−E_{D1}]; and

the ξ is an amplification effect of a secondary development of water flooding effect and a tertiary oil recovery effect for theoretically recognizing a increased value of the recovery ratio under the secondary-tertiary combination development mode.

Through the above technical solutions, a new sweep coefficient calculation model may be established according to the percentages of sweep coefficients increased by different development methods under injection-production conditions of the primary oil recovery, thereby obtaining a recovery ratio calculation model under the secondary-tertiary combination development mode. The increment ΔE_{R2+3} in the recovery ratio as determined in the present disclosure amplifies the effect of the secondary development of water flooding and that of the tertiary oil recovery, which may be used for theoretically understanding the increased value of the recovery ratio under the secondary-tertiary combination development mode.

### BRIEF DESCRIPTION OF DRAWINGS

FIG. 1 is a flow chart of a method for calculating a recovery ratio according to the present disclosure.

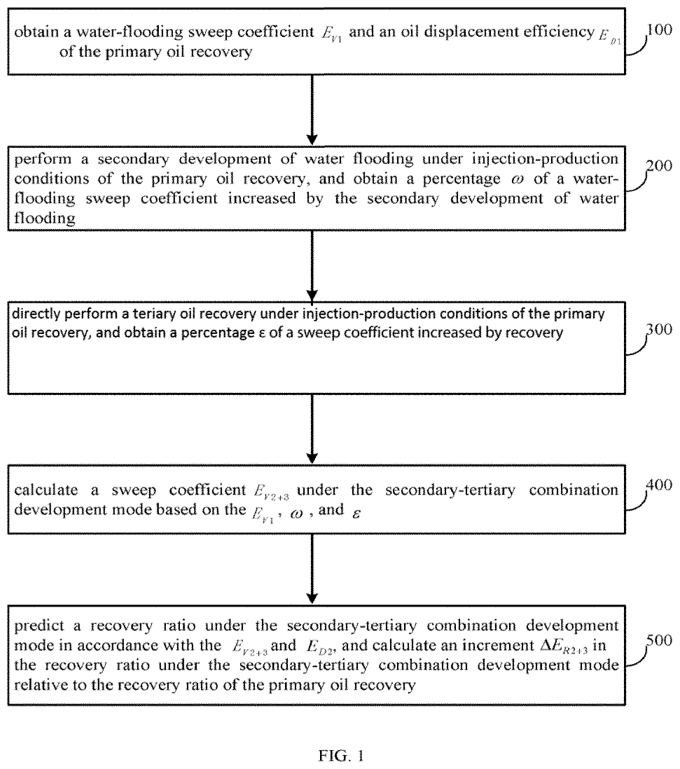

### DETAILED DESCRIPTION OF THE EMBODIMENTS

The specific embodiments of the present disclosure will be further illustrated in detail in combination with the accompanying drawings hereinafter. It should be understood that the specific embodiments described herein merely illustrate and explain the present disclosure, and does not limit the present disclosure.

The method of applying the secondary-tertiary combination development mode into the high water-cut oilfield comprises: firstly arranging a dense well network to second and third oil layers when the oil production of the second and third oil layers as obtained by the primary oil recovery reaches an economic efficiency limit; performing water flooding for potential seeking with selective perforations on structural units and single sand layers that are incompletely produced in the thick oil layer, establishing a new flooding system, and improving the injection-production correspondence relationship to reduce the impact of heterogeneity; and then, transferring to the tertiary oil recovery of chemical flooding in due course, and increasing the viscosity of the formation water by injecting chemicals to thereby improve the viscosity ratio of the crude oil to the formation water and meanwhile reduce the adsorption of the crude oil on rocks. In this way, the sweep efficiency and oil displacement efficiency of the displacement medium can be improved effectively, thereby achieving the object of improving the development water-flooding effect and enhancing the crude oil recovery ratio.

The secondary-tertiary combination development mode is committed to optimize the link between the tertiary oil recovery and the secondary water flooding for potential seeking, and has an ultimate goal of maximizing the total recovery ratio and optimizing the economic efficiency. In this specific embodiment, a secondary development of water flooding is firstly performed until a water content reaches at 98%, and then 0.25 PV polymer flooding is performed.

The present disclosure provides a method for calculating a recovery ratio under a secondary-tertiary combination development mode, and the method comprises steps as follows.

step 100, a water-flooding sweep coefficient E_{V1} and an oil displacement efficiency E_{D1} of the primary oil recovery are obtained.

step 200, a secondary development of water flooding is performed under injection-production conditions of the primary oil recovery, and a percentage ω of a water-flooding sweep coefficient increased by the secondary development of water flooding is obtained.

step 300, a tertiary oil recovery is directly performed under injection-production conditions of the primary oil recovery, and a percentage ε of a sweep coefficient increased by the tertiary oil recovery and an oil displacement efficiency E_{D2} of the tertiary oil recovery are obtained.

step 400, a sweep coefficient E_{V2+3} under the secondary-tertiary combination development mode is calculated based on the water-flooding sweep coefficient E_{V1} of the primary oil recovery, the percentage ω of the water-flooding sweep coefficient increased by the secondary development of water flooding, and the percentage ε of the sweep coefficient increased by the tertiary oil recovery.

In step 400, the sweep coefficient E_{V2+3} under the secondary-tertiary combination development mode is calculated in accordance with a formula (1).

E_{V2+3}=E_{V1}×(1+ω)×(1+ε) Formula (1)

step 500, a recovery ratio under the secondary-tertiary combination development mode is predicted in accordance with the calculated sweep coefficient E_{V2+3} under the secondary-tertiary combination development mode and the oil displacement efficiency E_{D2} of the tertiary oil recovery; and a recovery ratio increment ΔE_{R2+3} under the secondary-tertiary combination development mode relative to the recovery ratio of the primary oil recovery is calculated.

In step 500, the recovery ratio increment ΔE_{R2+3} under the secondary-tertiary combination development mode relative to the recovery ratio of the primary oil recovery is calculated in accordance with a formula (2).

ΔE_{R2+3}=E_{V2+3}×E_{D2}−E_{V1}×E_{D1} Formula (2)

The sweep coefficient refers to the extent to which the displacement medium is swept in the oil layer. In this embodiment of the present disclosure, the sweep coefficient is defined as the ratio of the volume of the oil layer displaced by the displacement medium to the total volume of the reservoir. The sweep coefficient increases with the development time until the pressure wave is transmitted to a control boundary of the well network.

The primary oil recovery is to produce oil with development of water flooding. According to the step 200, under injection-production conditions of the primary oil recovery, the development of the hierarchical well network is reorganized to construct a secondary development water-flooding well network structure, so that the water-flooding sweep coefficient E_{V1} of the primary oil recovery in the oil reservoir can be improved, and the increased value of the water-flooding sweep coefficient is marked as a percentage ω of the water-flooding sweep coefficient increased by the secondary development well network.

The percentage ω of the water-flooding sweep coefficient increased by the secondary development water-flooding well network is namely the difference value between the water-flooding sweep coefficient after the secondary development improves the injection well network and the water-flooding sweep coefficient E_{V1} of the primary oil recovery. The calculation formula is as follows:

$$ω = \frac{{A}_{2} {h}_{2} - {A}_{1} {h}_{1}}{A h}$$

In the above formula, A, A₁, and A₂ respectively denote the reservoir area, the primary development water-flooding sweep area and the secondary development water-flooding sweep area; and h, h₁, and h₂ respectively denote the oil reservoir thickness, the primary water-flooding sweep thickness and the secondary water-flooding sweep thickness.

Furthermore, ω can be determined according to the plane sweep area under different well network manners and the extent to which the oil layers are utilized by a combination of different hierarchical developments in a longitudinal direction. As found through experiments, the sweep area is related to the fluidity ratio, which can be determined by drawing a relationship diagram between the area sweep coefficient and the fluidity ratio under the condition of five-point well networks. The sweep volume is equal to the product of the sweep area and the sweep thickness, based on which the relationship between the volume sweep coefficient and the fluidity ratio can be derived. With the development of water flooding, the extent to which the oil layers are utilized will decrease, so that ω may change with the time of the development water flooding. Thus, ω is a function that changes with time, and its trend may be fitted through a plurality of experiments, so that the relationship between ω and the time of the water flooding can be obtained.

According to a preferred embodiment of the present disclosure, a secondary development of water flooding is performed under injection-production conditions of the primary oil recovery, and the water-flooding sweep coefficient E_{V2} of the secondary development of water flooding is calculated in accordance with a formula (3).

E_{V2}=E_{V1}×(1+ω) Formula (3)

For the step 300, the tertiary oil recovery is directly implemented on the basis of the same hierarchical well network of the primary oil recovery. The tertiary oil recovery is generally chemical flooding, which includes polymer flooding and ternary composite flooding, and further includes foam flooding, alkaline water flooding, active water flooding, micellar solution flooding, microemulsion low-tension flooding, and the like.

Taking the polymer flooding as an example, the polymer flooding is directed to displace the oil by injecting a polymer injected into the stratums. Macroscopically, the polymer increases the viscosity of the displacement medium and reduces the water-oil mobility ratio, thereby expanding the sweep volume of the displacement medium. Thus, on the basis of the water-flooding sweep coefficient E_{V1} of the primary oil recovery, the polymer flooding may increase the volume sweep coefficient of the displacement medium in the reservoir, which is marked as the percentage ε of the sweep coefficient increased by the oil displacement agent of the tertiary oil recovery. The ε changes with the time of the tertiary oil recovery, the formula of which is as follows:

$$ɛ = \frac{{A}_{3} {h}_{3} - {A}_{1} {h}_{1}}{A h}$$

In the above formula, A, A₁, and A₃ respectively denote the reservoir area, the primary development water-flooding sweep area and the tertiary oil recovery sweep area; and h, h₁, and h₃ respectively denote the oil reservoir thickness, the primary water-flooding sweep thickness and the tertiary oil recovery sweep thickness.

Among them, the tertiary oil recovery sweep area A₃ can be obtained through physical simulation experiments, or can be calculated by the quasi-flow tube method.

According to a preferred embodiment of the present disclosure, a tertiary oil recovery may be directly performed under injection-production conditions of the primary oil recovery, and the sweep coefficient E_{V3} of the tertiary oil recovery is calculated in accordance with a formula (4).

E_{V3}=E_{V1}×(1+ε) Formula (4)

Microscopically, due to the inherent viscoelasticity of the polymer, the oil film or oil droplets are stretched during the flow procedure, which increases the carrying capacity and improves the micro oil-washing efficiency, so that the oil displacement efficiency E_{D2} of the tertiary oil recovery is also improved.

The oil displacement efficiency refers to the micro-displacement efficiency, which is the ratio of the oil production in the area swept by the displacement medium to the oil reserves. The oil displacement efficiency coefficient gradually increases with the time until the reservoir is washed to a residual oil state. In practical applications, the oil displacement efficiency

$${E}_{D} = \frac{{S}_{1} - {S}_{2}}{{S}_{1}} \times 100 \%$$

can be calculated according to the oil saturation or water saturation in the region swept by the displacement medium.

When the oil displacement efficiency is calculated based on the oil saturation, the S₁ denotes the original oil saturation in the region swept by the displacement medium, and S₂ denotes the residual oil saturation after the oil recovery.

When the oil displacement efficiency is calculated based on the water saturation, the S₁ denotes the original water saturation in the region swept by the displacement medium, and S₂ denotes the residual water saturation after the development.

According to a preferred embodiment of the present disclosure, the sweep coefficient E_{V2+3} under the secondary-tertiary combination development mode is calculated based on E_{V2} and E_{V3}.

The secondary-tertiary combination development concept means to combine the secondary oil recovery with the tertiary oil recovery organically by comprehensively utilizing a set of oil recovery system and perform water flooding for potential seeking to the residual-oil-enriched second and third oil layers before the tertiary oil recovery. This method improves the effect of the development water flooding, extends the valid period of the development water flooding, and provides sufficient time for the later chemical flooding technology that aims to significantly improve the oil recovery ratio.

The above formula (1) combines advantages of the secondary oil recovery that has a delicate well network with the efficiency of the tertiary oil recovery that improves the recovery ratio, so that the sweep coefficient E_{V2+3} under the secondary-tertiary combination development mode may be significantly improved.

For the step 500, according to the formula for calculating recovery ratio, recovery rate=sweep coefficient×oil displacement efficiency. Thus, a recovery ratio E_{R1} of the primary oil recovery can be calculated in accordance with a formula (6) based on the water-flooding sweep coefficient E_{V1} and the oil displacement efficiency E_{D1} of the primary oil recovery.

E_{R1}=E_{V1}×E_{D1} Formula (5)

Furthermore, the secondary development of water flooding is performed under injection-production conditions of the primary oil recovery. The calculation model of the sweep coefficient E_{V2} of the secondary development of water flooding is as shown in formula (3), and the water flooding efficiency is E_{D1}, so that the recovery ratio of the secondary development of water flooding is E_{R2}=E_{V2}×E_{D1}.

In the embodiment of the present disclosure, an increment ΔE_{R2} in the recovery ratio of the secondary development of water flooding relative to the recovery ratio of the primary oil recovery is calculated according to a formula (6).

ΔE_{R2}=E_{V2}×E_{D1}−E_{R1} Formula (6)

Furthermore, the tertiary oil recovery is directly performed under injection-production conditions of the primary oil recovery. The calculation model of the sweep coefficient E_{V3} of the tertiary oil recovery is as shown in formula (4), and the oil displacement efficiency of the oil displacement agent is E_{D2}, so that the recovery ratio of the tertiary oil recovery is E_{R3}=E_{V3}×E_{D2}.

In the embodiment of the present disclosure, an increment ΔE_{R3} in the recovery ratio of the tertiary oil recovery relative to the recovery ratio of the primary oil recovery is calculated according to a formula (8).

ΔE_{R3}=E_{V3}×E_{D2}−E_{R1} Formula (7)

Furthermore, the calculation model of the sweep coefficient E_{V2+3} of the secondary-tertiary combination development mode is as shown in formula (1), and the oil displacement efficiency is E_{D2}, and the recovery ratio E_{R2+3} under the secondary-tertiary combination development mode is anticipated in accordance with a formula (8).

E_{R2+3}=E_{V2+3}×E_{D2} Formula(8)

In the embodiment of the present disclosure, an increment ΔE_{R2+3} in the recovery ratio of the secondary-tertiary combination development mode relative to the recovery ratio of the primary oil recovery is calculated according to a formula (9).

ΔE_{R2+3}=E_{V1}(1+ω)×(1+ε)×E_{D2}−E_{V1}×E_{D1} Formula (9)

Table 1 shows a comparison of recover ratios in the above development methods.

TABLE 1

| | | Secondary | | |
|---|---|---|---|---|
| | Primary | development | Tertiary oil | Secondary-tertiary |
| | oil recovery | water-flooding only | recovery directly | combination |
| Sweep coefficient calculation model | ${E}_{V 1}$ | $\begin{matrix}{E}_{V 1} \times ω \\ {E}_{V 1}\end{matrix}$ | $\begin{matrix}{E}_{V 1} \times ɛ \\ {E}_{V 1}\end{matrix}$ | $\begin{matrix}{E}_{V 1} \times ( 1 + ω ) \times ɛ \\ {E}_{V 1} \times ω \\ {E}_{V 1}\end{matrix}$ |
| Sweep coefficient | E_{V1} | E_{V1} × (1 + ω) | E_{V1} × (1 + ε) | E_{V1} × (1 + ω) × (1 + ε) |
| Oil displacement | E_{D1} | E_{D1} | E_{D2} | E_{D2} |
| efficiency | | | | |
| Predicted | E_{V1} × E_{D1} | E_{V1} × (1 + ω) × E_{D1} | E_{V1} × (1 + ε) × E_{D2} | E_{V1} × (1 + ω) × (1 + ε) × E_{D2} |
| recovery ratio | | | | |
| Increment in | / | E_{V1} × (1 + ω) × | E_{V1} × (1 + ε) × | E_{V1} × (1 + ω) × (1 + ε) × |
| recovery ratio | | E_{D1} − E_{V1} × E_{D1} | E_{D2} − E_{V1} × E_{D1} | E_{D2} − E_{V1} × E_{D1} |

Further, by combining the formula (7) with the formula (8), the formula (9) is transformed into:

ΔE_{R2+3}=ΔE_{R2}+ΔE_{R3}+ξ Formula (10)

ξ=E_{V1}=ω×[(1+ε)×E_{D2}−E_{D1}] Formula (11)

It can be seen from the formula (10) that the increment ΔE_{R2+3} in the recovery ratio in the secondary-tertiary combination development project is much higher than a sum of the increment ΔE_{R2} in the recovery ratio achieved by performing the secondary development of water flooding project alone and the increment ΔE_{R3} in the recovery ratio achieved by performing the tertiary oil recovery project alone. Thus, the increment value ξ is a value obtained by the secondary-tertiary combination development mode that exerts a cooperation effect by integrating the advantage of the secondary development that has an integrated well network and the advantage of the tertiary oil recovery that can improve the oil displacement efficiency, which is an amplifier to improve the recovery ratio relative to performing the secondary development of water flooding alone and performing the tertiary oil recovery alone. That is, ξ is an amplification effect of a secondary development of water flooding effect and a tertiary oil recovery effect, and can be used to theoretically understand the increased value in the recovery ratio under the secondary-tertiary combination development mode. The formula (11) and formula (12) are the theory basis based on which the secondary-tertiary combination development mode improves the recovery ratio and realizes an effect of “1+1>2”. The secondary-tertiary combination development mode improves the overall benefits of the oilfield development.

The preferred embodiments of the present disclosure have been described in detail above, but the present disclosure is not limited thereto. Within the scope of the technical concept of the present disclosure, various simple variations can be made to the technical solution of the present disclosure, including the combination of various technical features in any other suitable manner. These simple variations and combinations should also be considered as the content disclosed by the present disclosure and also fall within the protection scope of the present disclosure.

1. A method comprising:
obtaining a water flooding sweep coefficient E_{V1} and an oil displacement efficiency E_{D1} for a well network of an oil field;
injecting water in wells of the well network to perform a secondary development of water flooding with injection-production conditions, and obtaining percentage of the E_{V1}, ω, caused by the secondary development of water flooding;
chemical flooding of the wells to directly perform tertiary oil recovery with injection-production conditions, and obtaining a percentage of the E_{V1}, ε, caused by the tertiary oil recovery and an oil displacement efficiency of the tertiary oil recovery E_{D2};
calculating a sweep efficient E_{V2+3} in accordance with a formula (1)
E_{V2+3}=E_{V1}×(1+ω)×(1+ε) Formula (1);
predicting a recovery ratio under the secondary-tertiary combination development mode in accordance with the calculated E_{V2+3} and the E_{D2}, obtaining a recovery ratio of the primary oil recovery based on the E_{V1} and the E_{D1}, and calculating an increment in the recovery ratio relative to the recovery ratio of the primary oil recovery ΔE_{R2+3} in accordance with a formula (2),
ΔE_{R2+3}=E_{V2+3}×E_{D2}−E_{V1}×E_{D1} Formula (2), and
establishing a new flooding system for the oil field based on the increment in the recovery ratio to conduct improved water flooding followed by chemical flooding of the well network and enhance crude oil recover from the well network.

2. The method according to claim 1, wherein calculating E_{V2+3} comprises:
calculating a sweep efficiency of water used in the process of the secondary development E_{V2+3} in accordance with a formula (3);
E_{V2}=E_{V1}×(1+ω) Formula (3),
calculating a sweep efficiency of a displacement medium used in the process of the tertiary oil recovery E_{V3} in accordance with a formula (4); and
E_{V3}=E_{V1}×(1+ε) Formula (4),
calculating Eᵥ₂₊₃ of the formula (1) based on E_{V2} and E_{V3}.

3. The method according to claim 2, wherein
a formula for calculating the recovery ratio is as follows: recovery ratio=sweep efficiency×oil displacement efficiency,
the recovery ratio E_{R1} of the primary oil recovery is calculated in accordance with a formula (5) based on E_{V1} and E_{D1};
E_{R1}=E_{V1}×E_{D1} Formula (5)
an increment in the recovery ratio of the secondary development of water flooding relative to the recovery ratio of the primary oil recovery ΔE_{R2} is calculated in accordance with a formula (6) based E_{V2} and an oil displacement efficiency of the secondary development of water flooding, which is equal to E_{D1};
ΔE_{R2}=E_{V2}×E_{D1}−E_{R1} Formula (6)
and an increment in a recovery ratio of the tertiary oil recovery relative to the recovery ratio of the primary oil recovery ΔE_{R3} is calculated in accordance with a formula (7) based on the E_{V3} and the E_{D2}
ΔE_{R3}=E_{V3}×E_{D2}−E_{R1} Formula (7).

4. The method for calculating a recovery ratio according to claim 3, further comprising:
predicting the recovery ratio E_{R2+3} in accordance with a formula (8) based on the E_{V2+3} and the E_{D2}; and
E_{R2+3}=E_{V2+3}×E_{D2} Formula (8)
calculating an increment in the recovery ratio under the secondary-tertiary combination development mode relative to the recovery ratio of the primary oil recovery ΔE_{R2+3} in accordance with a formula (9);
ΔE_{R2+3}=E_{V1}(1+ω)×(1+ε)×E_{D2}−E_{V1}×E_{D1} Formula(9),
wherein ΔE_{R2+3}ΔE_{R2}+ΔE_{R3}+ξ can be obtained from ΔE_{R2} and ΔE_{R3}; and
wherein ξ=E_{V1}×ω×[(1+ε)×E_{D2}−E_{D1}]; and is an amplification effect of a secondary development of water flooding effect and a tertiary oil recovery effect for indicating an increased value of the recovery ratio.
